(19) United States
(12) Patent Application Publication
(10) Pub. No.: US 2006/0077213 A1
(43) Pub. Date: Apr. 13, 2006

(54) Video conversion system and method

(75) Inventor: Gang Li, San Jose, CA (US)

Correspondence Address: CARR & FERRELL LLP, 2200 GENG ROAD, PALO ALTO, CA, 94303, US

(73) Assignee: Chrontel, Inc.

(21) Appl. No.: 11/099,400

(22) Filed: Apr. 4, 2005

Related U.S. Application Data
(60) Provisional application No. 60/615,156, filed on Sep. 30, 2004.

(51) Int. Cl. H04N 9/74; G09G 5/00

(52) U.S. Cl. 345/660; 348/581

(57) ABSTRACT

A video conversion system receives a luminance image and a chrominance image of a video image. The video conversion system vertically scales the luminance image and the chrominance image. The video conversion system then horizontally scales the video image based on the vertically scaled luminance image and the vertically scaled chrominance image to generate a scaled video image.

### CROSS-REFERENCE TO RELATED APPLICATION

This application claims benefit of U.S. Provisional Patent Application No. 60/615,156 entitled “Video Conversion System and Method,” filed on Sep. 30, 2004, which is incorporated by reference herein.

### BACKGROUND

1. Field of the Invention

The present invention relates generally to format conversion of video images, and more particularly, to systems and methods of converting a computer video signal into a television signal.

2. Background Art

An increasing number of different visual display formats are used for displaying video images in consumer electronic devices, such as personal computers. These visual display formats typically vary in resolution, size or aspect ratio. Similarly, many different television formats are defined by various television standards. These television standards define resolutions, sizes and aspect ratios of a television display for displaying video images. Moreover, many consumers seek to display video images generated by consumer electronics devices on a television display.

In addition to differing resolution, size and aspect ratios between visual display formats and television standards, a consumer electronics device may use a different method than that specified in a television standard for generating video images. Typically, a consumer electronic device uses a progressive method to generate a video image. In such a progressive method, lines of a video image are generated progressively from the top of the video image to the bottom of the video image. Further, sequential video images are generated to create a visual effect on a video display.

Although television standards may specify a progressive method for generating visual images, television standards may instead specify an interlaced method for generating visual images. In the interlaced method, a video image has a first field and a second field. The first field contains odd lines of the video image and the second field contains even lines of the video image. In this way, the lines of the first field are interlaced with the lines of the second field. Similar to the progressive method, the lines in each field are generated from the top of the field to the bottom of the field. Further, the video image is displayed by first generating the lines in the first field and then generating the lines in the second field. In both the progressive and interlaced methods, sequential video images are generated to create a visual effect on a television display.

One consequence of the interlaced method is that a viewer may notice aliasing or flickering in the visual images generated on a television display. This aliasing may occur if the luminance or chrominance of two adjacent interlaced lines substantially differs from each other. Accordingly, known video converters filter video images to reduce aliasing.

One difference between a typical consumer electronic device and a television display is that a television typically overscans a video image such that a portion of the video image is outside an active area (i.e., visible area) of the television display. In contrast to a television, a typical consumer electronic device displays an entire video image in an active area of a video display. Many well-known video converters compensate for television overscan such that substantially the entire content of the video image is within the active area of the television display.

Some well-known video converters include frame buffers to facilitate conversion of video images generated by consumer electronic devices into a television signal. In these video converters, an input frame buffer stores an input video image. Various conversion functions, such as scaling, filtering and overscan compensation, are then performed on the input video image in the frame buffer to create an output video image in an output frame buffer. The output video image is then encoded into a television signal. Depending upon the sizes of the input and output video images, these frame buffers may be costly. For instance, large frame buffers may increase a part count of a video converter or increase size of an integrated circuit containing the frame buffers. Other well-known video converters constrain the scaling ratio between input video images and output video images to reduce the cost and complexity of the video converter. Once such a video converter is manufactured, however, the video converter cannot support another scaling ratio.

In view of the above, there exists a need for an improved system and method of converting video images into a format for displaying the video images on a television display.

### SUMMARY OF THE INVENTION

A video conversion system addresses the need for converting video images generated by an electronic device to display the video images on a television display. In various embodiments, a video image is translated into a luminance image and a chrominance image. A first scaling module vertically scales the luminance image based on one or more vertical scaling coefficients. Similarly, a second scaling module vertically scales the chrominance image based on the vertical scaling coefficients. A horizontal scaler horizontally scales the vertically scaled luminance image and the vertically scaled chrominance image to generate a scaled video image. The scaled video image is then encoded to generate an output video signal for displaying the scaled video image on a television display.

A system in accordance with embodiments the present invention includes a vertical scaler in communication with a horizontal scaler. The vertical scaler includes a first scaling module and a second scaling module. The first scaling module is configured to vertically scale a luminance image of a video image. The second scaling module is configured to vertically scale a chrominance image of the video image. The horizontal scaler is configured to horizontally scale the video image based on the scaled luminance image and the scaled chrominance image.

A method in accordance with embodiments the present invention includes vertically scaling a luminance image and a chrominance image of a video image. Further, the method includes horizontally scaling the video image based on the vertically scaled luminance image and the vertically scaled chrominance image.

### BRIEF DESCRIPTION OF THE DRAWINGS

FIG. 1 is a block diagram of an exemplary computing environment in which a video conversion system in accordance with embodiments of the present invention can be practiced;

FIG. 2 is a block diagram of an exemplary video conversion system;

FIG. 3 is a block diagram of an exemplary vertical scaler of the exemplary video conversion system;

FIG. 4 illustrates exemplary vertical scaling coefficients for a down-scaling operation;

FIG. 5 illustrates exemplary vertical scaling coefficients for an up-scaling operation;

FIG. 6 illustrates exemplary horizontal scaling coefficients for a horizontal scaling operation;

FIG. 7 illustrates an exemplary vertical scaling module of the vertical scaler;

FIG. 8 is a block diagram of an exemplary clock generator of the video conversion system;

FIG. 9 is a block diagram of an exemplary centering unit of the video conversion system;

FIG. 10 is a flow chart for an exemplary method of converting a video image into a scaled video image in accordance with one embodiment of the present invention;

FIG. 11 illustrates a flow chart showing further details for vertically scaling a video image.

### DETAILED DESCRIPTION OF THE EMBODIMENTS

In accordance with embodiments of the present invention, a luminance image of a video image is vertically scaled to generate a vertically scaled luminance image. Similarly, a chrominance image of the video image is vertically scaled to generate a vertically scaled chrominance image. The vertically scaled luminance image and the vertically scaled chrominance image are horizontally scaled to generate a scaled video image.

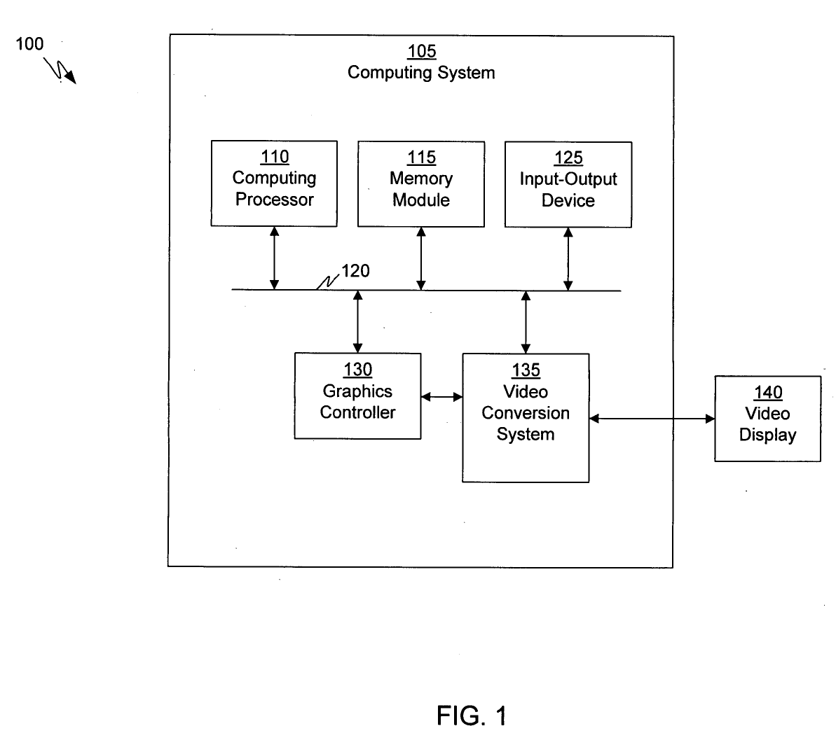

FIG. 1 illustrates an exemplary computing environment 100 in which a video conversion system 135 in accordance with the present invention can be practiced. The computing environment 100 includes a computing system 105 and a video display 140. The computing system 105 includes a computing processor 110, a memory module 115, an input-output (I/O) device 125, and a graphics controller 130. The computing processor 110, the memory module 115, the input-output device 125, the graphics controller 130, and the video conversion system. 135 are in communication with each other via a computer bus 120. Additionally, the video conversion system 135 is in communication with the video display 140. The input-output device 125 receives input data from a user and provides output data to the user. For example, the input-output device 125 may be a computer keyboard and a computer monitor. The graphics controller 130 generates video images, and the video conversion system 135 converts the video images for display on the video display 140. For example, the video display 140 may be a television.

In various embodiments, the video conversion system 135 vertically and horizontally scales a video image to generate a scaled video image. In one embodiment, the video conversion system 135 down-scales the video image such that a number of output video lines in the scaled video image is less than a number of input video lines in the video image. In another embodiment, the video conversion system 135 up-scales the video image such that a number of output video lines in the scaled video image is greater than a number of input video lines in the video image. In still another embodiment, the video conversion system 135 down-scales or up-scales the video image based on user supplied conversion parameters.

In one embodiment, the video conversion system 135 converts a video image having a progressive video format into a scaled video image having an interlaced video format. In another embodiment, the video conversion system 135 converts a video image having an interlaced video format into a scaled video image having a progressive video format. In still another embodiment, the video conversion system 135 converts a video image having either a progressive or an interlaced video format into a scaled video image having either a progressive or an interlaced video format. In a further embodiment, the video conversion system 135 centers the scaled video image for presentation on the video display 140.

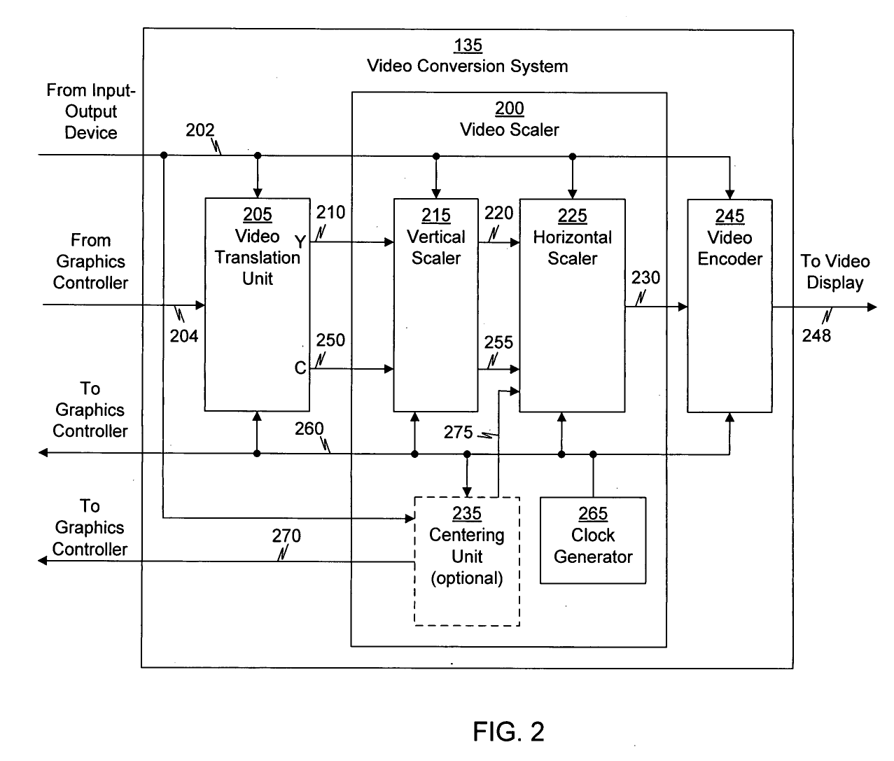

FIG. 2 illustrates an exemplary video conversion system 135 in accordance with one embodiment. The exemplary video conversion system 135 includes a video scaler 200, a video translation unit 205, a vertical scaler 215, a horizontal scaler 225, an optional centering unit 235, a video encoder 245, and a clock generator 265. The video translation unit 205 translates a video image into a luminance image and a chrominance image. The vertical scaler 215 vertically scales the luminance image and the chrominance image. The horizontal scaler 225 horizontally scales the video image based on the vertically scaled luminance image and the vertically scaled chrominance image to generate a scaled video image. The optional centering unit 235 centers the scaled video image. The video encoder 245 encodes the scaled video image to generate an output video signal 248, such as a television signal. The clock generator 265 synchronizes operation of the video conversion system 135 with the graphics controller 130 (FIG. 1) and the video display 140 (FIG. 1). Additionally, the clock generator 265 may synchronize operation of the video translation unit 205, the vertical scaler 215, the horizontal scaler 225, the centering unit 235, and the video encoder 245.

In one embodiment, the video translation unit 205 can translate the video image from a progressive format to an interlaced format, or from an interlaced format to a progressive format, or both. In this embodiment, the video translation unit 205 receives one or more conversion parameters and determines whether to translate the video image into another format based on these conversion parameters. For example, a user may supply the conversion parameters via the input-output device 125 (FIG. 1).

In various embodiments, the vertical scaler 215 and the horizontal scaler 225 receive one or more conversion parameters from the input-output device 125. In these embodiments, the vertical scaler 215 vertically scales the luminance image and the chrominance image based on the conversion parameters, and the horizontal scaler 225 horizontally scales the video image based on the conversion parameters. In a further embodiment, the centering unit 235 receives one or more conversion parameters from the input-output device 125 and centers the scaled video image based on these conversion parameters. In another further embodiment, the video encoder 245 receives one or more conversion parameters from the input-output device 125 and encodes the scaled video image based on these conversion parameters.

In one embodiment, the video translation unit 205 receives an input video signal 204 comprising the video image. For example, the video translation unit 205 can receive the input video signal 204 from the graphics controller 130. In this embodiment, the video translation unit 205 generates a luminance video signal 210 comprising the luminance image and a chrominance video signal 250 comprising the chrominance image. In a further embodiment, the video translation unit 205 converts the video image from a progressive format to an interlaced format, or from an interlaced format to a progressive format.

In one embodiment, the input video signal 204 is a video graphics array (VGA) signal including a red color component (R), a green color component (G), and a blue color component (B). In this embodiment, the video translation unit 205 converts the input video signal 204 into a luminance-bandwidth-chrominance (YUV) signal including a luminance component (Y), a first chrominance component (U), and a second chrominance component (V). Further, the luminance video signal 210 includes the luminance component, and the chrominance video signal 250 includes both the first chrominance component and the second chrominance component. In a further embodiment, the video translation unit 205 multiplexes the first chrominance component and the second chrominance component such that the chrominance video signal 250 includes a multiplexed chrominance component.

In one embodiment, the vertical scaler 215 receives the luminance video signal 210 and generates a scaled luminance video signal 220 comprising the scaled luminance image. Further, the vertical scaler 215 receives the chrominance video signal 250 and generates a scaled chrominance video signal 255 comprising the scaled chrominance image. In this embodiment, the horizontal scaler 225 receives the scaled luminance video signal 220 and the scaled chrominance video signal 255 from the vertical scaler 215 and generates a scaled video signal 230 comprising the scaled video image.

In one embodiment, the centering unit 235 generates a vertical centering signal 270 and a horizontal centering signal 275. The centering unit 235 provides provides the vertical centering signal 270 to the graphics controller 130 and the horizontal centering signal 275 to the horizontal scaler 225. In response to the vertical centering signal 270, the graphics controller 130 adjusts the input video signal 204 such that the scaled video image in the scaled video signal 230 is vertically centered for the video display 140. In response to the horizontal centering signal 275, the horizontal scaler 225 horizontally centers the scaled video image for the video display 140.

In one embodiment, the video encoder 245 receives the scaled video signal 230 from the horizontal scaler 225 and encodes the scaled video image in the scaled video signal 230 to generate an output video signal 248. The output video signal 248 is encoded in a video format for displaying the scaled video image on the video display 140. In various embodiments, the video format of the output video signal 248 is a television video format such as the National Television System Committee (NTSC) format or the Phase Alternation Line (PAL) format.

In various embodiments, the clock generator 265 generates a clock signal 260 for synchronizing operations of the video translation unit 205, the vertical scaler 215, the horizontal scaler 225, the centering unit 235, or the video encoder 245, or any combination thereof. In one embodiment, the clock signal 260 also synchronizes operation of the graphics controller 130 and the video display 140 with the video conversion system 135.

In various embodiments, the computing system 105 generates a control signal 202 comprising one or more conversion parameters. In these various embodiments, the vertical scaler 215 vertically scales the luminance image and the chrominance image based on the control signal 202, and the horizontal scaler 225 horizontally scales the video image based on the control signal 202. In a further embodiment, the centering unit 235 centers the scaled video image based on the control signal 202. In another further embodiment, the video encoder 245 encodes the scaled video image based on the control signal 202.

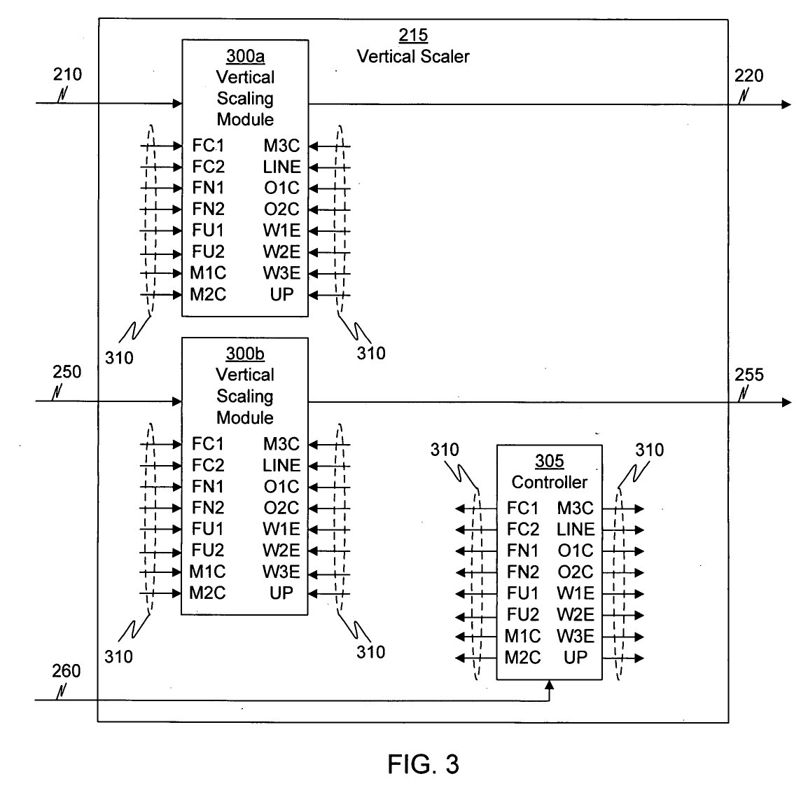

FIG. 3 illustrates an exemplary vertical scaler 215 of the video conversion system 135. The exemplary vertical scaler 215 includes two vertical scaling modules 300 (i.e., vertical scaling modules 300a and 300b) and a controller 305. The vertical scaling module 300a vertically scales the luminance image to generate the scaled luminance image, and the vertical scaling module 300b vertically scales the chrominance image to generate the scaled chrominance image. In one embodiment, the vertical scaling module 300a receives the luminance video signal 210 and generates the scaled luminance video signal 220 including the scaled luminance image. In this embodiment, the vertical scaling module 300b receives the chrominance video signal 250 and generates the scaled chrominance video signal 255 including the scaled chrominance image. In another embodiment, the vertical scaling module 300a and the vertical scaling module 300b are the same vertical scaling module 300.

The controller 305 generates control signals 310 for controlling operation of the vertical scaling modules 300. In response to the control signals 310, the vertical scaling modules 300 scale an input image (i.e., the luminance image for vertical scaling module 300a or the chrominance image for vertical scaling module 300b) to generate a scaled output image (i.e., the scaled luminance image for vertical scaling module 300a or the scaled chrominance image for vertical scaling module 300b). In one embodiment, the control signals 310 include the control signals FC1, FC2, FN1, FN2, FU1, FU2, M1C, M2C, M3C, LINE O1C, O2C, W1E, W2E, W3E, and UP, as is described more fully herein.

In one embodiment, the vertical scaling module 300 performs a down-scaling operation on the input image by performing a cascade filtering operation on the input image. The cascade filtering operation includes a low-pass filtering operation and an interpolation filtering operation. The low-pass filtering operation reduces the bandwidth of the input image to reduce flickering (e.g., aliasing) in the scaled output image. In one embodiment, the vertical scaling module 300 includes a low-pass filter for performing the low-pass filtering operation on the input image. In an alternative embodiment, the low-pass filtering operation is performed by downsampling the input image. In one embodiment, the vertical scaling module 300 includes a downsampler for performing the downsampling operation, as would be appreciated by those skilled in the relevant arts.

The interpolation filtering operation interpolates an output video line of the scaled output image (i.e., a video line of the scaled luminance image for the vertical scaling module 300a or a video line of the scaled chrominance image for the vertical scaling module 300b) based on two adjacent input video lines of the input image. In one embodiment, the vertical scaling module 300 interpolates the pixels of the output video line based on the corresponding pixels of the adjacent input video lines. For example, the pixels of each adjacent input video line can include luminance data and the vertical scaling module 300a can interpolate luminance data for each pixel in the output video line based on the luminance data in the corresponding pixels of the adjacent input video lines. As another example, the pixels of each adjacent input video line can include chrominance data and the vertical scaling module 300b can interpolate chrominance data for each pixel in the output video line based on the chrominance data in the corresponding pixels of the adjacent input video lines.

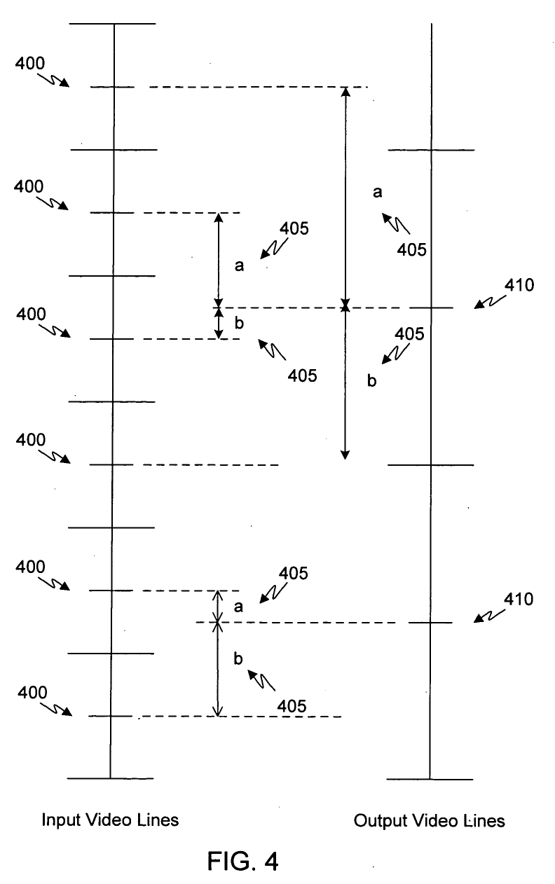

FIG. 4 illustrates exemplary vertical scaling coefficients 405 for a down-scaling operation. In the down-scaling operation, the vertical scaler 215 (FIG. 2) computes one or more of the vertical scaling coefficients 405 for an output video line 410 of the scaled output image generated by the vertical scaling module 300 (FIG. 300). In one embodiment, each of the vertical scaling coefficients 405 of the output video line 410 represents a distance between the center of the output video line 410 and the center of an input video line 400 of the input image. Moreover, the vertical scaling module 300 interpolates the output video line 410 based on the vertical scaling coefficients 405. For example, the vertical scaling module 300 can use the coefficients to assign a greater weight to an input video line 400 closer to the output video line 410 in a vertical direction than another input video line 400 further from the output video line 410 in a vertical direction.

In one embodiment, the vertical scaling module 300 interpolates an output video line 410 based on the two adjacent input video lines 400 closest to the output video line 410 as indicated by the vertical scaling coefficients 405. In this way, the vertical scaling module 300 performs a down-scaling operation on the adjacent input video lines 400 to generate the output video line 410. In another embodiment, the vertical scaling module 300 reduces the bandwidth of a block of input video lines 400 and interpolates an output video line 410 based on the vertical scaling coefficients of the input video lines 400 in the block of input video lines 400. In this embodiment, the vertical scaling module 300 includes a vertical scaling filter for performing the down-scaling operation. The vertical scaling filter is a cascade filter including a low-pass filter for reducing the bandwidth of the input video lines and an interpolation filter for interpolating the output video line.

TABLE 1
Characteristics of exemplary vertical scaling filter.

| | | | Coefficients | | | | | | | |
|---|---|---|---|---|---|---|---|---|---|---|
| | # of | | Tap count | | | | | | | |
| | input | | 1 | 2 | 3 | 4 | 5 | 6 | 7 | |
| | video | | Tap index | | | | | | | |
| Index | lines | Filter | −3 | −2 | −1 | 0 | 1 | 2 | 3 | BW |
| 0 | 2 | [b a] | 0 | 0 | 0 | b | a | 0 | 0 | |
| 1 | 3 | [b a] | 0 | 0 | b/2 | (a + b)/2 | a/2 | 0 | 0 | 0.565 |
| | | [1 1]/2 | | | | | | | | |
| 2 | 4 | [b a] | 0 | 0 | b/4 | (2b + a)/4 | (b + 2a)/4 | a/4 | 0 | 0.36 |
| | | [1 2 1]/4 | | | | | | | | |
| 3 | 4 | [b a] | 0 | 0 | 5b/16 | (6b + 5a)/16 | (5b + 6a)/16 | 5a/16 | 0 | 0.325 |
| | | [5 6 5]/16 | | | | | | | | |
| 4 | 4 | [b a] | 0 | 0 | 2b/8 | (3b + 2a)/8 | (2b + 3a)/8 | 2a/8 | 0 | 0.29 |
| | | [3 2 3]/8 | | | | | | | | |
| 5 | 5 | [b a] | 0 | 5b/32 | (11b + 5a)/32 | (11b + 11a)/32 | (5b + 11a)/4 | 5a/32 | 0 | 0.276 |
| | | [1 1] | | | | | | | | |
| | | [5 6 5]/32 | | | | | | | | |
| 6 | 6 | [b a] | 0 | 5b/64 | (16b + 5a)/64 | (22b + 16a)/64 | (16b + 22a)/64 | (5b + 16a)/64 | 5a/64 | |
| | | [1 2 1] | | | | | | | | |
| | | [5 6 5]/64 | | | | | | | | |
| 7 | 7 | [b a] | 15b/256 | (43b + 15a)/256 | (70b + 43a)/256 | (70b + 70a)/256 | (43b + 70a)/256 | (15b + 43a)/256 | 15a/256 | |
| | | [1 1] | | | | | | | | |
| | | [3 2 3] | | | | | | | | |
| | | [5 6 5]/256 | | | | | | | | |

Tap coefficients for exemplary vertical scaling filters are listed in Table 1, in which the bandwidth is normalized to the Nyquist frequency and the vertical scaling filters are indexed in descending order of cut-off frequency. As indicated in Table 1, a vertical scaling filter can perform a down-scaling operation on two to seven input video lines 400, each of which represents a filter tap having a non-zero filter coefficient. A tap count identifies the filter tap and the coefficients of the filter tap. A tap index identifies an input video line 400 for the filter tap. For example, the exemplary vertical scaling filter can perform a down-scaling operation on two adjacent input video lines 400 based on two filter taps referenced by tap counts four and five, as indicated in the first row of Table 1 (i.e., row index 0). Moreover, the filter coefficients (i.e., a and b) of the filter taps are the vertical scaling coefficients 405 of the two adjacent input video lines 400. Further in this example, the tap indexes 0 and 1 identify the adjacent input video lines 400.

In one embodiment, the vertical scaling filter can perform a down-scaling operation on a selected number of input video lines 400 (e.g., a block of input video lines 400). In this embodiment, the vertical scaler 215 determines the selected number of input video lines 400 based on the conversion parameters. In this way, the vertical scaler 215 is programmable to scale the input image based on the conversion parameters. Additionally, the vertical scaler 215 can compute the vertical scaling coefficients 405 and the filter coefficients of the vertical scaling filter in real time to vertically scale the video image in real time. Further, the vertical scaling module 300 can perform a down-scaling operation on the selected number of input video lines 400 to generate an output video line 410 in real time based on the filter coefficients.

The filter length (i.e., the number of filter taps) of the vertical scaling filter is based on a selected number of input video lines 400 in the video image that are filtered to generate an output video line 410. In various embodiments, the vertical scaler 215 is limited to a maximum number of input video lines 400 (filterlenmax). In these embodiments, the maximum number of input video lines 400 may be computed based on the number of input video lines 400 in the video image and the number of output video lines 410 in the scaled video image. For a conversion of a video image having a progressive video format to a scaled video image having a progressive video format, the maximum filter length is computed as follows:
Filterlenmax=int(2×TVI/TVO)+1,
where TVI is the number of input video lines in the video image, and TVO is the number of output video lines in the scaled video image.

For a conversion of a video image having a progressive video format to a scaled video image having an interlaced video format, the maximum filter length may be computed as follows:
Filterlenmax=int(4×TVI/TVO)+1,
where TVI is the number of input video lines in the video image and TVO is the number of output video lines in the scaled video image.

In another embodiment, the vertical scaler 215 performs vertical overscan compensation on the video image. The controller 305 computes a selected number of input video lines for the video image based on the number of output video lines and the number of active output video lines in the output image, and generates a vertical overscan signal indicating the selected number of input video lines. In response to the vertical overscan signal, the graphics controller 130 adds additional input video lines to the active input video lines of the video image such that the video image has the selected number of input video lines. For example, the graphics controller 130 can append vertical blanking lines to the top and bottom of the vertical image. In the scaled luminance and chrominance images, these vertical blanking lines are outside the active area of the video display 140. In this way, the vertical scaler 215 performs vertical overscan compensation on the video image.

The selected number of input video lines (VTI) for the video image may be computed based on the number of active input video lines (VAI) in the video image and a vertical overscan compensation value (VOVER) as indicated in Table 2. The vertical overscan compensation value ranges from zero to a hundred-and-twenty-seven (127), and corresponds to a vertical overscan compensation percentage (VOV) range of zero to fifty (50). The relationship of the vertical overscan compensation value and the vertical overscan compensation percentage is as follows:
VOV=a(1+a),

where a=VOVER/128

TABLE 2
Equations for Computing Input Video Lines
for Vertical Overscan Compensation

| Output Video Lines of | | |
|---|---|---|
| Television System | | Total Input Video Lines (VTI) |
| 525 | lines | VTI = VAI*(525/480)*(1 + VOVER/128) = |
| | | VAI*(35/32)*(1 + VOVER/128) |
| 625 | lines | VTI = VAI*(625/576)*(1 + VOVER/128) = |
| | | VAI*(139/128)*(1 + VOVER/128) |
| 750 | lines | VTI = VAI*(750/720)*(1 + VOVER/128) = |
| | | VAI*(133/128)*(1 + VOVER/128) |
| 1125 | lines | VTI = VAI*(1125/1080)*(1 + VOVER/128) = |
| | | VAI*(133/128)*(1 + VOVER/128) |
| | | VTI = VAI*(1125/1035)*(1 + VOVER/128) = |
| | | VAI*(139/128)*(1 + VOVER/128) |
| 1250 | lines | VTI = VAI*(1250/1080)*(1 + VOVER/128) = |
| | | VAI*(37/32)*(1 + VOVER/128) |

In another embodiment, the vertical scaler 215 performs horizontal overscan compensation on the video image. The controller 305 effectively decreases the number of active pixels in the output video lines of the scaled video image to squeeze the scaled video image in a horizontal direction. For example, the controller 305 can adjust one or more conversion parameters specifying a resolution, size or aspect ratio of the scaled video image and generate the horizontal scaling coefficients based on the adjusted conversion parameters to decrease the number of active pixels in the output video lines of the scaled video image. The horizontal scaler 225 horizontally scales the video image based on these horizontal scaling coefficients to generate the scaled video image having approximately the same width as the active area of the video display 140. The scaled output image can then be horizontally centered such that the active pixels of the output video lines are within the active area of the video display 140, as is described more fully herein.

In one embodiment, the horizontal scaler 225 performs horizontal overscan compensation by adjusting a horizontal increment (HINC), which indicates the distance between the centers of adjacent output pixels in an output video line. The adjusted horizontal increment may be computed based on a horizontal overscan compensation value (HOVER), which corresponds to horizontal overscan compensation percent (HOV). The relationship of the horizontal overscan compensation value and the horizontal overscan compensation percent is as follows:
HOV=a(1+a),
where a=HOVER/128

The adjusted horizontal increment may be computed based on the number of active pixels in an input video line (HAI), the number of active pixels in an output video line (HAO), and the horizontal overscan compensation value (HOVER) as follows:
HINC=HAI×(1/HAO)×2²⁰×(1+HOVER/128),

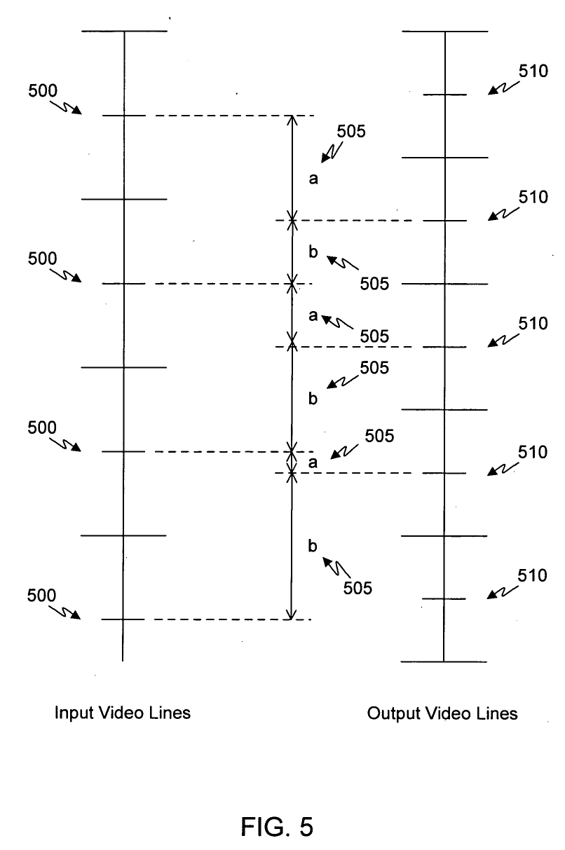

FIG. 5 illustrates exemplary vertical scaling coefficients 505 for an up-scaling operation. In the up-scaling operation, the vertical scaler 215 (FIG. 2) computes one or more vertical scaling coefficients 505 for an output video line 510 of a scaled output image generated by the vertical scaling module 300 (FIG. 3; i.e., the scaled luminance image for vertical scaling module 300a or the scaled chrominance image for vertical scaling module 300b). In one embodiment, each of the vertical scaling coefficients 505 of an output video line 510 represents a distance between the center of the output video line 510 and the center of an input video line 500 of the input image received by the vertical scaling module 300. Moreover, the vertical scaling module 300 interpolates the output video line 510 based on the vertical scaling coefficients 505. For example, the vertical scaling module 300 can use the vertical scaling coefficients 505 to assign a greater weight to an input video line 500 closer to the output video line 510 in a vertical direction than another input video line 500 further from the output video line 510 in a vertical direction.

In one embodiment, the vertical scaler 215 computes a pair (i.e., a and b) of vertical scaling coefficients 505 for each output video line 510. The pair of scaling coefficients 505 represents the distances between the center of the output video line 510 and the centers of two adjacent input video lines 500 closest to the output video line 510 in a vertical direction. In another embodiment, the vertical scaling module 300 performs the up-scaling operation by interpolating the pixels of the output video line 510 based on the pixels of the adjacent input video lines 500. For example, the pixels of each adjacent input video line 500 can include luminance data, and the vertical scaling module 300a can interpolate luminance data for each pixel in the output video line 510 based on the luminance data in the corresponding pixels of the adjacent input video lines 500. As another example, the pixels of each adjacent input video line 500 can include chrominance data and the vertical scaling module 300b can interpolate chrominance data for each pixel in the output video line 510 based on the chrominance data in the corresponding pixels of the adjacent input video lines 500.

In another embodiment, the vertical scaler 215 determines whether to perform a down-scaling operation or an up-scaling operation on the video image based on the conversion parameters. The vertical scaler 215 then provides a control signal 310 (FIG. 3; e.g., the control signal UP) to the vertical scaling modules 300 indicating whether the vertical scaling modules 300 are to perform a down-scaling operation or an up-scaling operation on the input images received by the vertical scaling modules 300.

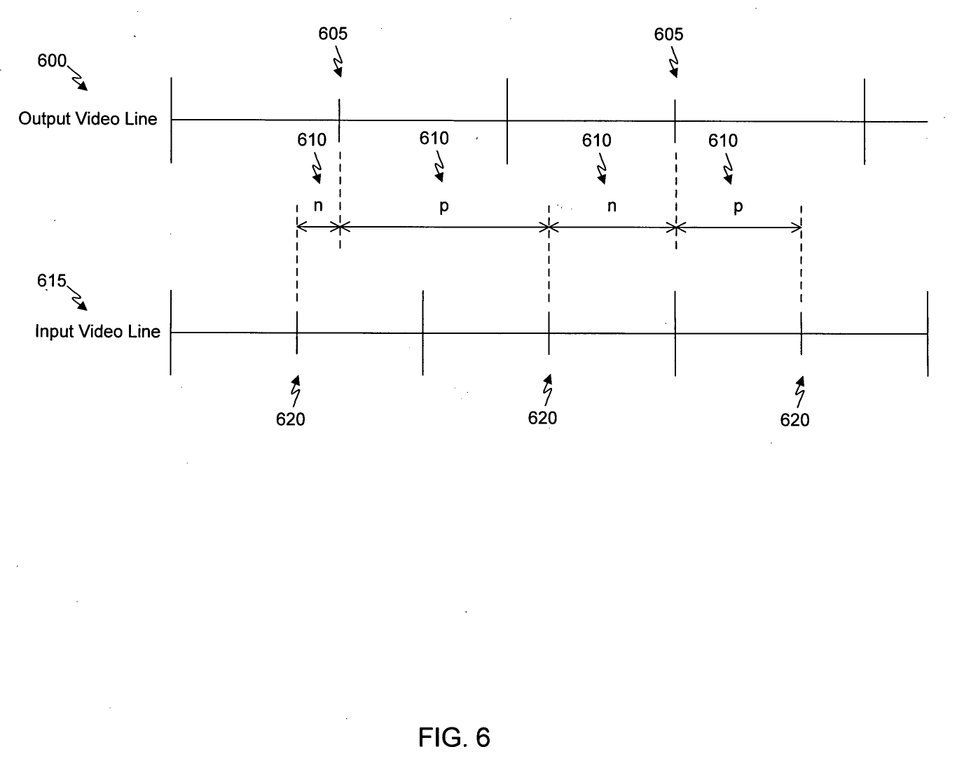

FIG. 6 illustrates exemplary horizontal scaling coefficients 610 for a horizontal scaling operation. In the horizontal scaling operation, the horizontal scaler 225 (FIG. 2) computes one or more horizontal scaling coefficients 610 for each output pixel 605 of an output video line 600 in the scaled video image. In one embodiment, each of the horizontal scaling coefficients 610 of the output pixel 605 represents a distance between the center of the output pixel 605 and the center of an input pixel 620 of an input video line 615. Moreover, the output pixels 605 of the output video line 600 include both horizontally scaled luminance data and horizontally scaled chrominance data of the scaled video image. The input video line 615 is an output video line of the scaled luminance image generated by the vertical scaling module 300a (FIG. 3) or an output video line 600 of the scaled chrominance image generated by the vertical scaling module 300b (FIG. 3). The horizontal scaler 225 interpolates the output video line 600 based on the horizontal scaling coefficients 610. In one embodiment, the horizontal scaler 225 interpolates an output pixel 605 of the output video line 600 based on the two adjacent input pixels 620 in the input video line 615 closest to the output pixel 605. For example, the horizontal scaler 225 can use the horizontal scaling coefficients to assign a greater weight to the adjacent input pixel 620 closer to the output pixel 605 in a horizontal direction than the adjacent input pixel 620 further from the output pixel 605 in a horizontal direction.

In various embodiments, the horizontal scaler 225 horizontally scales the luminance data in an input video line 615 of the scaled luminance image to generate horizontally scaled luminance data for an output video line 600 in the scaled video image. In this way, the horizontally scaled luminance data of the scaled video image is both vertically scaled and horizontally scaled. Similarly, the horizontal scaler 225 horizontally scales the chrominance data of the input video line 615 in the scaled chrominance image to generate horizontally scaled chrominance data of the output video line 600. In this way, the horizontally scaled chrominance data of the scaled video image is both vertically and horizontally scaled.

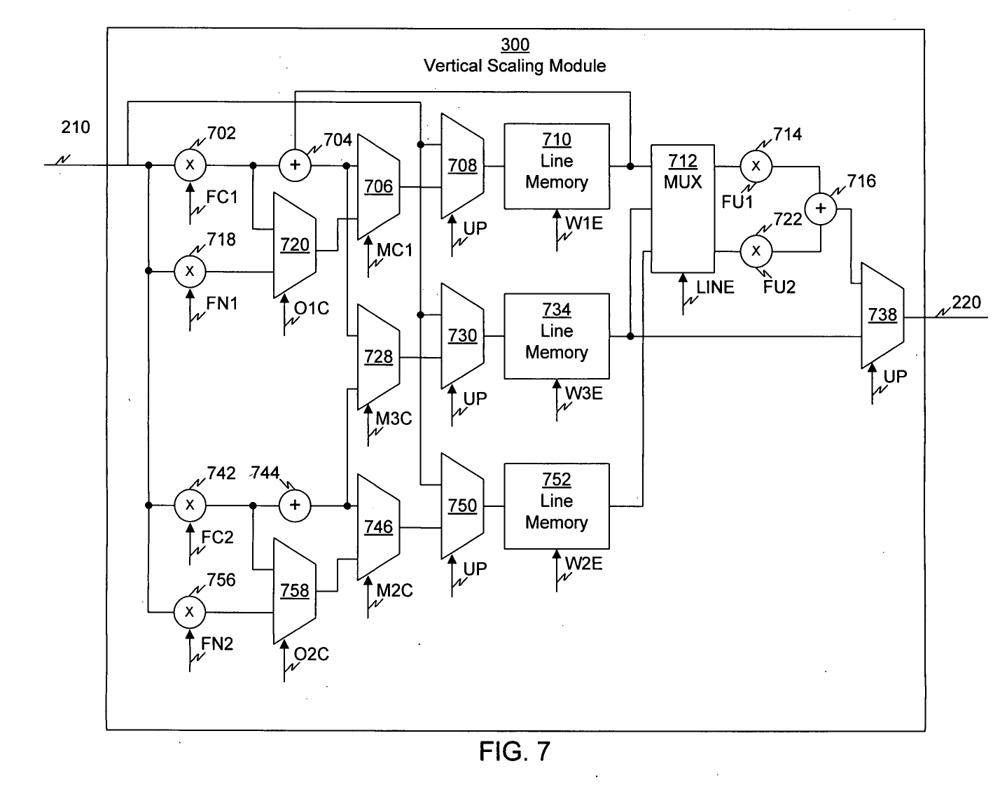

FIG. 7 illustrates an exemplary vertical scaling module 300 of the exemplary vertical scaler 215 (FIG. 3). The exemplary vertical scaling module 300 comprises two vertical scaling filters. A first vertical scaling filter includes two multipliers 702 and 718, an adder 704, three multiplexers 720, 706, and 708, and a line memory 710. The second vertical scaling filter includes two multipliers 742 and 756, an adder 744, three multiplexers 758, 746, and 750, and a line memory 752. Additionally, the first vertical scaling filter and the second vertical scaling filter are each coupled in communication with a line memory 734 via a multiplexer 728 and a multiplexer 730.

In one embodiment, each of the vertical scaling filters receives one or more input video lines and performs a down-scaling operation on the input video lines to generate an output video line, as is described more fully herein. The vertical scaling filters then store the output video lines into the line memory 734. Because the down-scaling operations of the first vertical scaling filter and the second vertical scaling filter overlap, the vertical scaling filters alternate storing output video lines into the line memory 734. Moreover, the vertical scaling module 300 outputs the output video line currently stored in the line memory 734 via a multiplexer 738.

Further in this embodiment, the line memory 734 serves as a buffer between the video translation unit 205 (FIG. 2) and the horizontal scaler 225 (FIG. 2) because the number of input pixels in the input video lines may differ from the number of output pixels in the output video line. In this embodiment, the vertical scaling filters receive input pixels of the input video line at an input pixel rate, and the horizontal scaler 225 reads the output pixels from the line memory 734 at an output pixel rate. In an alternative embodiment, the vertical scaling module 300 reads the output pixels from the line memory 734 and provides the output pixels to the horizontal scaler 225 at the output pixel rate. The input pixel rate is based on the frequency of the clock signal 260 and the output pixel rate is based on the frequency of a clock signal in the video display 140 (FIG. 1).

In one embodiment, the first vertical scaling filter performs a down-scaling operation in response to the control signals FC1, FN1, O1C, MC1, and UP generated by the controller 305 (FIG. 3). The control signal UP indicates that the vertical scaling module 300 is to perform a down-scaling operation. The control signal FC1 includes a current filter coefficient of the first vertical scaling filter and controls operation of the multiplier 702. The control signal FN1 includes a next filter coefficient of the first vertical scaling filter and controls operation of the multiplier 718. The control signal O1C indicates an overlapping input video line between the first vertical scaling filter and the second vertical scaling filter. The control signal MC1 selects intermediate output video lines for storage into the line memory 710 during the down-scaling operation. The controller 305 computes the first filter coefficient in the control signal FC1 and the second filter coefficient in the control signal FN1.

In one embodiment, the controller 305 computes these filter coefficients based on a tap count and a tap index as described more fully herein in connection with Table 1. In this embodiment, the tap index indicates the current input video line received by the vertical scaling filter and the tap count indicates the iteration number of the vertical scaling filter. In operation, the multiplier 702 receives a current input video line via either the luminance video signal 210 or a chrominance video signal 250 (not shown in FIG. 7), and multiplies the data (i.e., the luminance data or chrominance data) of the current input video line times the current filter coefficient in response to the control signal FC1 to generate an intermediate output video line. The multiplexers 720, 706, and 708 pass the intermediate output video line to the line memory 710 based on the respective control signals O1C, MC1, and UP, and the line memory 710 stores the intermediate output video line in response to the W1E control signal. In this way, the first vertical scaling filter performs an iteration.

The multiplier 702 then receives the next input video line via either the luminance video signal 210 or the chrominance video signal 250 (not shown in FIG. 7) and the control signal FC1 provides a current filter coefficient (i.e., the filter coefficient for the current input video line) to the multiplier 702. The multiplier 702 multiplies the data of the current input video line times the current filter coefficient in response to the control signal FC1 to generate another intermediate output video line. The adder 704 then adds together the intermediate output video line generated by the multiplier 702 and the intermediate output video line stored in the line memory 710 to generate another intermediate output video line. The multiplexers 706 and 708 pass this intermediate output video line from the adder 704 to the line memory 710 based on the respective control signals MC1 and UP, and the line memory 710 stores this intermediate output video line in response to the control signal W1E. In this way, the first vertical scaling filter performs another iteration. This process is repeated until the multiplier receives the input video line for the last tap of the first vertical scaling filter.

For the input video line of the last tap, the multiplier 702 multiplies the data of this input video line times the current filter coefficient in response to the control signal FC1 to generate an intermediate output video line. The adder 704 then adds together the intermediate output video line generated by the multiplier 702 and the intermediate output video line stored in the line memory 710 to generate the output video line. The multiplexers 728 and 730 pass the output video line to the line memory 734 based on the control signals M3C and UP, and the line memory 734 stores the output video line in response to the control signal W3E. In this way, the first vertical scaling filter performs the last iteration of the down-scaling operation.

The down-scaling operation performed by the first vertical scaling filter is similar to the down-scaling operation performed by the second vertical scaling filter. In the second vertical scaling filter, however, the control signal FC2 controls the multiplier 742, the control signal FN2 controls the multiplier 756, the control signal O2C controls the multiplexer 758, the control signal M2C controls the multiplexer 746, and the control signal UP controls the multiplexer 750.

The vertical scaling module 300 further includes a multiplexer (MUX) 712, two multipliers 714 and 722, and an adder 716 for performing an up-scaling operation on input video lines. The vertical scaling module 300 performs the up-scaling operation in response to the control signals LINE, FU1, FU2, and UP generated by the controller 305 (FIG. 3). The control signal LINE controls operation of the multiplexer 712. The control signal UP indicates that the vertical scaling module 300 is performing an up-scaling operation. The control signal FU1 includes a first vertical scaling coefficient for the input video line and controls operation of the multiplier 714. The control signal FU2 includes a second vertical scaling coefficient for the input video line and controls operation of the multiplier 722.

In the up-scaling operation, the multiplexers 708, 730, and 750 pass the input video lines to the respective line memories 710, 734, and 752. The line memories 710, 734, and 752 store the input video lines in response to the respective control signals W1E, W2E, and W3E. Moreover, the controller 305 (FIG. 3) generates the control signals W1E, W2E, and W3E, such that the line memories 710, 734, and 752 function as a circular buffer for storing the input video lines. In this way, two input video lines can be accessed from two of the line memories 710, 734, and 752 while a third input video line is stored into another one of the line memories 710, 734, and 752.

The multiplexer 712 is a three-to-two multiplexer that selects two of the input video lines stored in two of the line memories 710, 734, and 752 based on the control signal LINE. In one embodiment, the controller 305 includes a modulo-3 counter that generates the control signal LINE. In this embodiment, the control signal LINE indicates the count of the modulo-3 counter. The multiplexer 712 passes one of the selected input video lines to the multiplier 714 and the other one of the selected input video lines to the multiplier 722. The multiplier 714 multiplies the data (e.g., luminance data or chrominance data) in the input video line received from the multiplexer 712 by the first vertical scaling coefficient of an output video line in response to the control signal FU1 to generate a first intermediate output video line. The multiplier 722 multiplies the data (e.g., luminance data or chrominance data) in the input video line received from the multiplexer 712 by the second vertical scaling coefficient of the output video line in response to the control signal FU2 to generate a second intermediate output video line. The adder 716 adds the first intermediate output video line and the second intermediate output video line to generate the output video line. The multiplexer 738 passes the output video line based on the control signal UP to generate a portion of the scaled luminance video signal 220 or the scaled chrominance video signal 255 (not shown in FIG. 7).

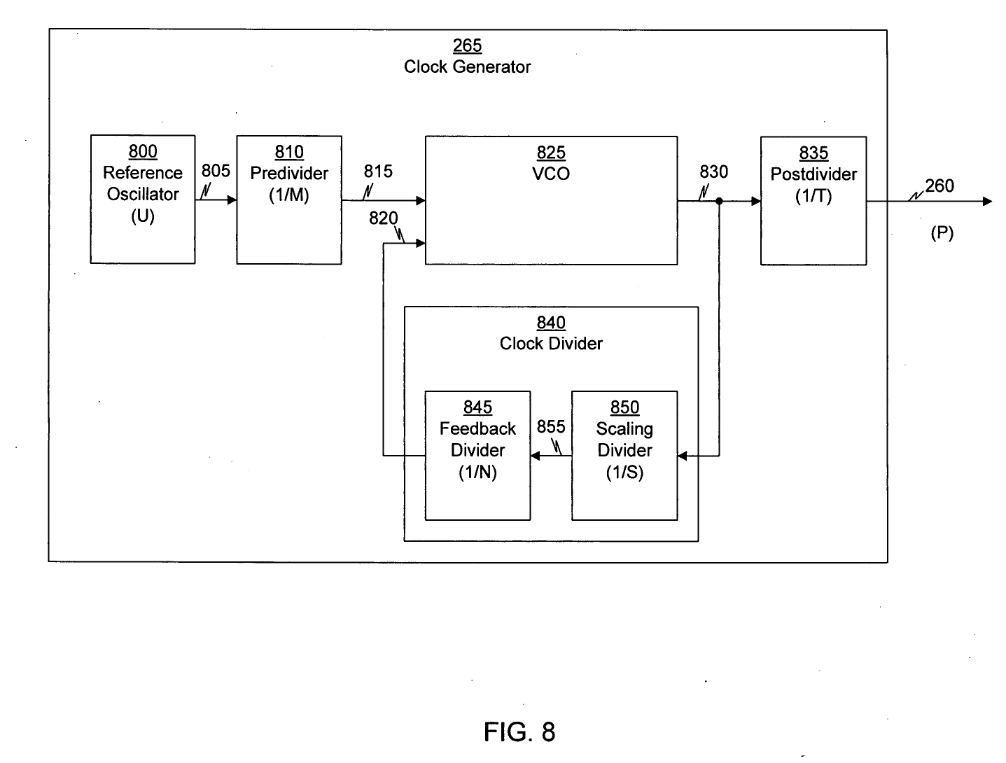

FIG. 8 illustrates an exemplary clock generator 265 (FIG. 2) of the exemplary video conversion system 135 (FIG. 2). The exemplary clock generator 265 includes a reference oscillator 800, a predivider 810, a voltage controlled oscillator (VCO) 825, a postdivider 835, and a clock divider 840. The VCO 825 and the clock divider 840 form a phase locked loop (PLL). The reference oscillator 800 generates a reference clock signal 805 having substantially the same frequency as a clock signal in the video display 140. For example, the reference oscillator 800 can be a clock circuit that uses a crystal for maintaining an accurate and stable reference frequency of the reference clock signal 805.

The predivider 810 divides the frequency of the reference clock signal 805 by a predetermined value M to generate a predivided clock signal 815. The voltage controlled oscillator 825 generates a controlled clock signal 830 based on the predivided clock signal 815 and a feedback clock signal 820. The postdivider 835 divides the frequency of the output clock signal 830 by a predetermined value T to generate the clock signal 260. The clock divider 840 divides the frequency of the controlled clock signal 830 by a predetermined value which is the product of a predetermined value N and a predetermined value S to generate the feedback clock signal 820.

The clock divider 840 includes a feedback divider 845 and a scaling divider 850. In one embodiment, the scaling divider 850 divides the frequency of the controlled clock signal 830 by a value S to generate a divided clock signal 855, and the feedback divider 845 divides the frequency of the divided clock signal 855 by a value N to generate the feedback clock signal 820. In an alternative embodiment, the feedback divider 845 divides the frequency of the controlled clock signal 830 by a value N to generate the divided clock signal 855, and the scaling divider 850 further divides the divided clock signal 855 by a value S to generate the feedback clock signal 820.

The frequency of the clock signal 260 is the input pixel rate (P) of the video scaler 200, which is based on the output pixel rate (U) of the video display 140, the number of input video lines (VTI) in the video image, the number of pixels per input video line (HTI), the number of output video lines (VTO) in the scaled video image, the number of pixels per output video line (HTO), and the conversion mode (IP) of the video translation unit 205 (FIG. 2). If the video translation unit 205 converts a video image having a progressive video format into luminance and chrominance images having a progressive video format, the conversion mode is equal to one. Similarly, if the video translation unit 205 converts a video image having an interlaced video format into luminance and chrominance images having a progressive video format, the conversion mode is equal to one. Alternatively, if the video translation unit 205 converts a video image having a progressive video format into luminance and chrominance images having an interlaced video format, the conversion mode is equal to two. The input pixel rate P of the video conversion system 130 may be computed as follows:
P=U*(HTI/HTO)*(VTI/VTO)*IP

In one embodiment, the values M, T, S, and N are integer values selected to simplify design of the clock generator 265 for various television standards. The ratio of HTI/HTO is set to the value of S/4, and the value of S is selected from a group containing the values one, two, three and four. The value M is selected such that M is equal to the number of output video lines (VTO) in the scaled video image as specified by a television standard divided by twenty-five (i.e., M=VTO/25). For example, the value of M may be selected from a group containing the values twenty-one, twenty-five, thirty, forty-five and fifty. If the conversion mode is set to one, the number of input video lines (VTI) is selected to be a multiple of ten and N is set to TVI/10. Alternatively, if the conversion mode is set to two, the number of input video lines (VTI) is selected to be a multiple of twenty and N is set to VTI/20. In this embodiment, the input pixel rate P of the video conversion system 130 may be expressed as follows:
P=(U*N*S)/(M*10)

Further, if T is set to a value of five (i.e., T=5), the input pixel rate P of the video conversion system 130 may be expressed as follows:
P=(U*N*S)/(M*T)

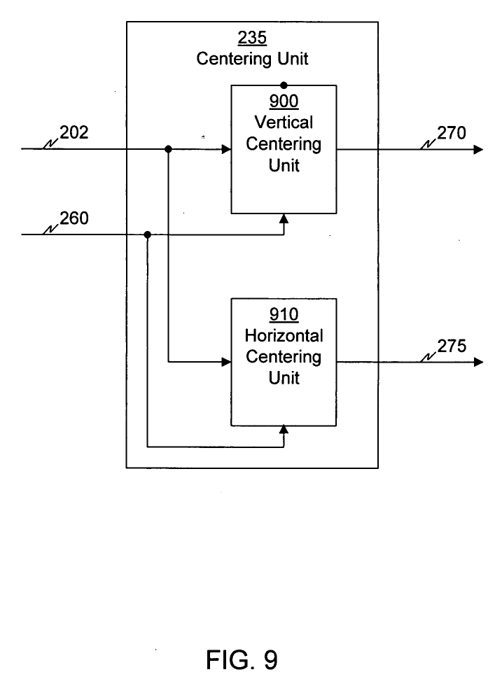

FIG. 9 illustrates an exemplary centering unit 235 of the exemplary video conversion system 135 (FIG. 2). The exemplary centering unit 235 includes a vertical centering unit 900 and a horizontal centering unit 910. The vertical centering unit 900 computes a vertical center offset to vertically center the scaled video image, generates the vertical centering signal 270 indicating the vertical center offset, and provides the vertical centering signal 270 to the graphics controller 130 (FIG. 1). In response to the vertical centering signal 270, the graphics controller 130 adjusts the vertical center of the video image such that scaled video image is vertically centered.

In one embodiment, the vertical center offset is an input vertical sync pulse offset (VOI). The input vertical sync pulse offset is computed based on the number of input video lines (VTI) and the number of active input video lines (VAI) in the video image, and the number of output video lines in the scaled video image. The input vertical sync pulse offsets for various television standards are listed in Table 3.

TABLE 3
Calculation of Input Vertical Sync pulse offset (VOI).

| Output Video Lines in | |
|---|---|
| Television Standard | Input vertical sync pulse offset (VOI) |
| 480 | VOI = (60/128)*VTI − VAI/2 |
| 576 | VOI = (60/128)*VTI − VAI/2 |
| 720 | VOI = (62/128)*VTI − VAI/2 |
| 1035 | VOI = (60/128)*VTI − VAI/2 |
| 1080 | VOI = (56/128)*VTI − VAI/2 |
| 1080 | VOI = (62/128)*VTI − VAI/2 |
| 1125 | VOI = (62/128)*VTI − VAI/2 |
| 1250 | VOI = (56/128)*VTI − VAI/2 |

The horizontal centering unit 910 computes a horizontal center offset to horizontally center the scaled video image, generates a horizontal centering signal 275 indicating the horizontal center offset, and provides the horizontal centering signal 275 to the horizontal scaler 225 (FIG. 2). In response to the horizontal centering signal 275, the horizontal scaler 225 adjusts the horizontal center of the video image such that the scaled video image is horizontally centered. In one embodiment, the horizontal centering unit 910 computes a start of active value (SAV) for the video image, which indicates the position of the first active pixel in an input video line. The horizontal scaler 225 then determines the start of the first active pixel in an output video line based on the start of active value.

The horizontal centering unit 910 may compute the start of active value based on the horizontal center (HCENTER) of the active pixels in an output video line and the number of active pixels in the output video line (HAO) as follows.
SAV=HCENTER−(HAO/2)

The horizontal centering unit 910 generates the horizontal centering signal 275 indicating the start of active value and provides the horizontal centering signal 275 to the horizontal scaler 225. In response to the horizontal centering signal 275, the horizontal scaler 225 adjusts the horizontal center of the video image such that the scaled video image is horizontally centered.

In one embodiment, the horizontal centering unit 910 adjusts the start of active pixel to account for horizontal overscan compensation. As is described more fully herein, horizontal overscan compensation reduces the number of active pixels in an output video line (HAO) to HAO/(1+a), where a=HOVER/128. The horizontal centering unit 910 computes the start of active value as follows:
SAV=HCENTER−(HAO/2)/(1+a),
where a=HOVER/128

In another embodiment, the horizontal centering unit 910 computes the start of pixel value using a numerical approximation to simplify circuitry of the horizontal centering unit 910. A numerical approximation for computing the start of pixel value is as follows:
SAV=HCENTER−(HAO/2)*(0.958−a/2),
where a=HOVER/128

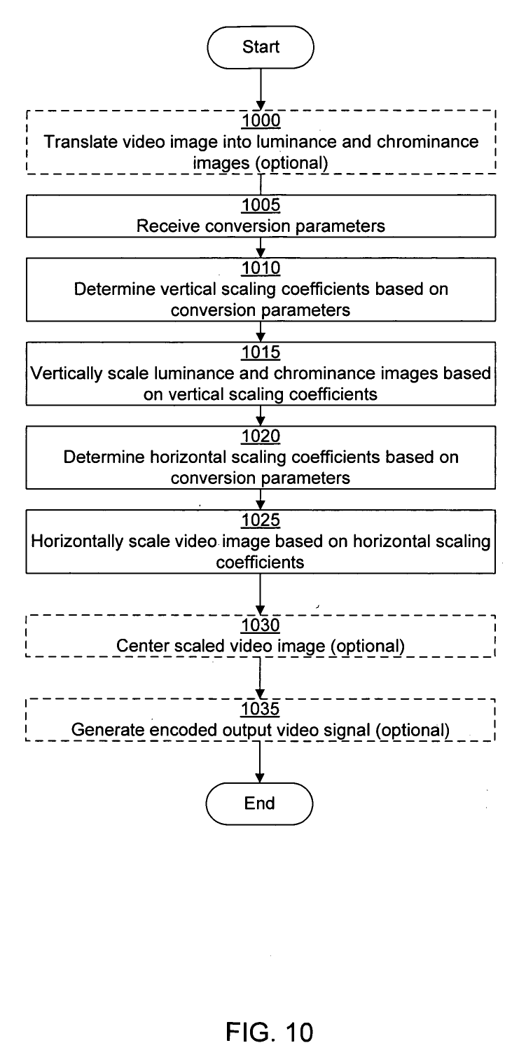

FIG. 10 illustrates an exemplary method of converting a video image into a scaled video image in accordance with one embodiment of the present invention. In step 1000, the video translation unit 205 (FIG. 2) translates the video image into a luminance image and a chrominance image. In one embodiment, the video translation unit 205 receives an input video signal 204 (FIG. 2) including the video image and translates the video signal into a luminance video signal 210 (FIG. 2) including the luminance image and a chrominance video signal 250 (FIG. 2) including the chrominance image. It is to be appreciated that step 1000 is optional in the present invention, and that the present invention can obtain the luminance image and the chrominance image from other sources.

In step 1005, the vertical scaler 215 (FIG. 2) receives one or more conversion parameters. In one embodiment, a user inputs the conversion parameters into the computing system (FIG. 1) via the input-output device 125. In this embodiment, the input-output device 125 provides the conversion parameters to the vertical scaler 215. In this way, the conversion parameters are programmable by the user. In a further embodiment, the vertical scaler 215 determines whether to perform a down-scaling operation or an up-scaling operation based on the conversion parameters.

In step 1010, the vertical scaler 215 determines the vertical scaling coefficients 405 (FIG. 4) for a down-sampling operation or the vertical scaling coefficients 505 (FIG. 5) for an up-scaling operation. In one embodiment, the vertical scaler 215 determines the vertical scaling coefficients 405 or 505 in real time, as is described more fully herein.

In step 1015, the vertical scaler 215 vertically scales the video image based on the vertical scaling coefficients 405 or 505. In one embodiment, the vertical scaling modules 300a and 300b (FIG. 3) perform a down-scaling operation on the video image. In this embodiment, the vertical scaling module 300a scales the luminance image based on the vertical scaling coefficients 405 to generate a scaled luminance image. Additionally, the vertical scaling module 300b vertically scales the chrominance image based on the vertical scaling coefficients 405 to generate a scaled chrominance image.

In another embodiment, the vertical scaling modules 300a and 300b perform an up-scaling operation on the luminance image. In this embodiment, the vertical scaling module 300a scales the luminance image based on the vertical scaling coefficients 505 to generate the vertically scaled luminance image. Additionally, the vertical scaling module 300b vertically scales the chrominance image based on the vertical scaling coefficients 505 to generate the vertically scaled chrominance image. In another embodiment, the vertical scaling module 300a generates a scaled luminance video signal 220 (FIG. 2) including the scaled luminance image, and the vertical scaling module 300b generates a scaled chrominance video signal 255 (FIG. 2) including the scaled chrominance image.

In step 1020, the horizontal scaler 225 (FIG. 2) determines the horizontal scaling coefficients 610 (FIG. 6) for a down-scaling operation or an up-scaling operation. In one embodiment, the horizontal scaler 225 determines the horizontal scaling coefficients 610 in real time, as is described more fully herein. In another embodiment, the horizontal scaler 225 determines whether to perform a down-scaling operation or an up-scaling operation based on the conversion parameters.

In step 1025, the horizontal scaler 225 horizontally scales the video image based on the horizontal scaling coefficients 610 to generate a scaled video image. In one embodiment, the horizontal scaler 225 scales the video image by scaling the luminance image and the chrominance image. In another embodiment, the horizontal scaler 225 generates a scaled video signal 230 (FIG. 2) including the scaled video image.

In step 1030, the centering unit 235 (FIG. 2) centers the scaled video image. In one embodiment, the vertical centering unit 900 computes a vertical center offset to vertically center the scaled video image, generates the vertical centering signal 270 indicating the vertical center offset, and provides the vertical centering signal 270 to the graphics controller 130 (FIG. 1). In response to the vertical centering signal 270, the graphics controller 130 adjusts the vertical center of the video image such that the scaled video image is vertically centered. The horizontal centering unit 910 computes a horizontal center offset to horizontally center the scaled video image, generates a horizontal centering signal 275 indicating the horizontal center offset, and provides the horizontal centering signal 275 to the graphics controller 130. In response to the horizontal centering signal 275, the graphics controller 130 adjusts the horizontal center of the video image such that the scaled video image is horizontally centered. It is to be appreciated that step 1030 is optional in accordance with various embodiments of the present invention.

In step 1035, the video encoder 245 (FIG. 2) encodes the scaled video signal 230 to generate an output video signal 248 (FIG. 2). In one embodiment, the output video signal 248 is a television signal in a standard television format. For example, the output video signal 248 can be in the NTSC format or the PAL format. In a further embodiment, the video encoder 245 receives one or more conversion parameters from the input-output device 125 and encodes the scaled video image based on these conversion parameters. The video display 140 can then receive the output video signal 248 and display the scaled video image. It is to be appreciated that step 1035 is optional in accordance with various embodiments of the present invention.

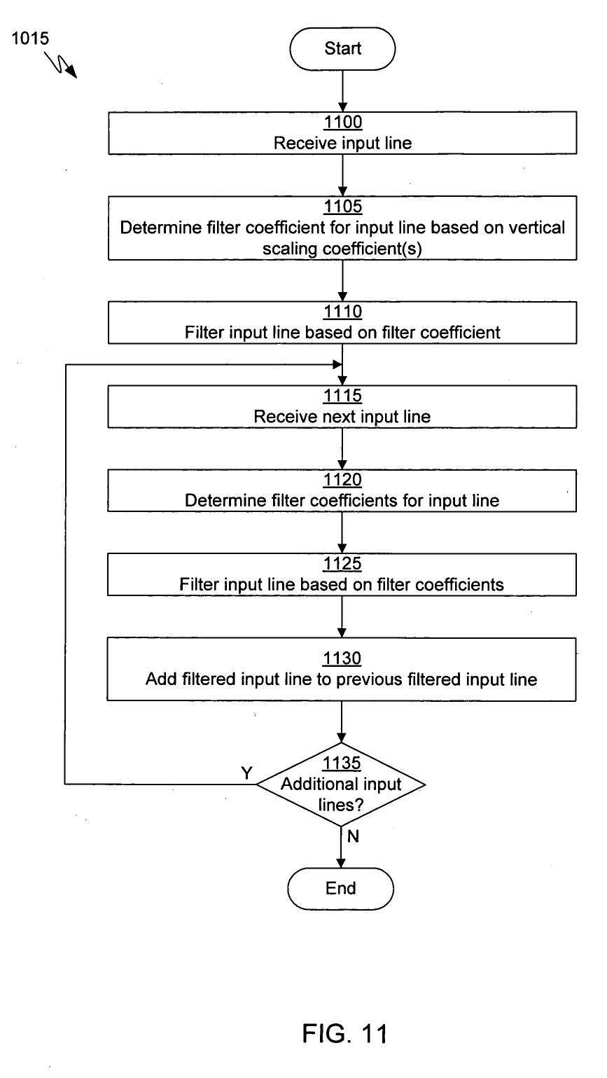

FIG. 11 illustrates further details of step 1015 (FIG. 10) for vertically scaling a video image. In step 1100, the vertical scaling module 300a (FIG. 3) receives an input video line of the luminance image. The input video line received by the vertical scaling module 300a is the first input video line of multiple input video lines to be down-scaled to generate the output video line.

In step 1105, the vertical scaler 215 (FIG. 2) determines the filter coefficient for the input video line based on a vertical scaling coefficient of the input video line. Example filter coefficients for an input video line are listed in Table 1.

In step 1110, the vertical scaling module 300a filters the input video line based on the filter coefficient. In one embodiment the vertical scaling module 300a filters the input video line by multiplying luminance data in the input video line times the filter coefficient to generate an intermediate output video line. Additionally, the vertical scaling module 300a stores the intermediate output video line for further computations, as is described more fully herein.

In step 1115, the vertical scaling module 300a receives the next input video line of the multiple input video lines to be down-scaled. In step 1120, the vertical scaler 215 determines the filter coefficient for this next input video line based on a vertical scaling coefficient of the input video line.

In step 1125, the vertical scaling module 300a filters this input video line to generate an intermediate output video line. In one embodiment, the vertical scaling module 300a filters the input video line by multiplying luminance data in the input video line times the filter coefficient.

In step 1130, the vertical scaling module 300a adds the intermediate output video line generated in step 1125 to the intermediate output video line stored in the vertical scaling module 300a.

In step 1135, the vertical scaling module 300a determines whether all the input video lines of the multiple input video lines are processed or additional input video lines are to be processed. If additional input video lines are to be processed, the method returns to step 1115. Otherwise, this portion of the method ends.

Although the vertical scaling module 300a vertically scales luminance data according to the portion of the method illustrated in FIG. 11, it is to be appreciated that the vertical scaling module 300b can vertically scale chrominance data in a similar manner.

The present invention has been described above with reference to exemplary embodiments. Other embodiments will be apparent to those skilled in the art in light of this disclosure. The present invention may readily be implemented using configurations other than those described in the exemplary embodiments above. Therefore, these and other variations upon the exemplary embodiments are covered by the present invention.

What is claimed is:

1. A system for scaling a video image, comprising:
a first vertical scaling module configured to vertically scale a luminance image of the video image;
a second vertical scaling module configured to vertically scale a chrominance image of the video image; and
a horizontal scaler in communication with the first vertical scaling module and the second vertical scaling module, the horizontal scaler configured to horizontally scale the video image based on the vertically scaled luminance image and the vertically scaled chrominance image to generate a scaled video image.

2. The system of claim 1, wherein the video image is an input video line and the scaled video image is a plurality of output video lines.

3. The system of claim 1, wherein the video image is a plurality of input video lines and the scaled video image is an output video line.

4. The system of claim 1, further comprising:
a controller in communication with the first vertical scaling module and the second vertical scaling module, the controller configured to receive a plurality of conversion parameters and compute a plurality of vertical scaling coefficients based on the conversion parameters, wherein the first vertical scaling module vertically scales the luminance image based on the plurality of vertical scaling coefficients and the second vertical scaling module vertically scales the chrominance image based on the plurality of vertical scaling coefficients.

5. The system of claim 4, wherein the controller is further configured to compute a plurality of horizontal scaling coefficients based on the plurality of conversion parameters, and wherein the horizontal scaler is further configured to horizontally scale the video image based on the plurality of horizontal scaling coefficients.

6. The system of claim 5, wherein the controller is further configured to compute the plurality of vertical scaling coefficients and the plurality of horizontal scaling coefficients in real time.

7. The system of claim 5, further comprising:
a computing processor;
a memory module in communication with the computing processor; and
an input-output device in communication with the computing processor, the first vertical scaling module, and the second vertical scaling module, the input-output device configured to receive the plurality of conversion parameters from a user.

8. The system of claim 7, further comprising a graphics controller configured to generate the video image.

9. The system of claim 8, further comprising a clock generator configured to synchronize the first vertical scaling module and the second vertical scaling module with the graphics controller.

10. The system of claim 9, wherein the clock generator comprises:
a reference oscillator configured to generate a reference clock signal;
a predivider configured to divide the reference clock signal by a predetermined value M to generate a predivided clock signal;
a voltage controlled oscillator configured to generate an output clock signal based on the predivided clock signal and a feedback clock signal; and
a clock divider configured to divide the output clock signal by a predetermined value S and a predetermined value N to generate the feedback signal.

11. The system of claim 10, wherein N represents a number of input video lines in the video image, N is an integer multiple of 10, and S is selected from a group consisting of the values 1, 2, 3 and 4.

12. The system of claim 1, further comprising a video translation unit in communication with the first vertical scaling module and the second vertical scaling module, the video translation unit configured to receive the video image and to translate the video image into the luminance image and the chrominance image.

13. The system of claim 1, further comprising a centering unit in communication with the horizontal scaler and configured to center the scaled video image.

14. The system of claim 1, wherein the video image comprises a plurality of input video lines and the scaled video image comprises a plurality of output video lines, the number of input video lines being a value within a predetermined range of integer values, the number of output video lines being a value within a predetermined range of integer values.

15. The system of claim 14, wherein the plurality of vertical scaling coefficients includes a first coefficient and a second coefficient for an output video line in the video image, the first coefficient indicating a vertical distance between the output video line and a first input video line of the video image, the second coefficient representing a vertical distance between the output video line and a second input video line of the video image.

16. The system of claim 15, wherein the first input video line is adjacent to the second input video line in the video image.

17. The system of claim 15, wherein the first vertical scaling module is further configured to interpolate luminance data of the output video line based on the first coefficient and the second coefficient, and the second vertical scaling module is further configured to interpolate chrominance data of the output video line based on the first coefficient and the second coefficient.

18. The system of claim 17, wherein the first vertical scaling module is further configured to filter the luminance data of the first input video line and the second input video line based on the first coefficient and the second coefficient, and the second vertical scaling module is further configured to filter the chrominance data of the first input video line and the second input video line based on the first coefficient and the second coefficient.

19. The system of claim 1, wherein the first vertical scaling module and the second vertical scaling module are the same vertical scaling module.

20. A method of scaling a video image, the method comprising:
vertically scaling a luminance image of the video image;
vertically scaling a chrominance image of the video image; and
horizontally scaling the video image based on the vertically scaled luminance image and the vertically scaled chrominance image to generate a scaled video image.

21. The method of claim 20, wherein the video image is an input video line and the scaled video image is a plurality of output video lines.

22. The method of claim 20, wherein the video image is a plurality of input video lines and the scaled video image is an output video line.

23. The method of claim 20, further comprising:
receiving a plurality of conversion parameters;
computing a plurality of vertical scaling coefficients based on the plurality of conversion parameters, wherein vertically scaling a luminance image of the video image is performed by using the plurality of vertical scaling coefficients, and wherein vertically scaling a chrominance image of the video image is performed by using the plurality of vertical scaling coefficients.

24. The method of claim 23, further comprising computing a plurality of horizontal scaling coefficients based on the plurality of conversion parameters, wherein horizontally scaling the video image is performed by using the plurality of horizontal scaling coefficients.

25. The method of claim 24, wherein computing a plurality of vertical scaling coefficients and computing a plurality of horizontal scaling coefficients are performed in real time.

26. The method of claim 20, further comprising generating the video image.

27. The method of claim 26, further comprising generating a clock signal to synchronize generating the video image, vertically scaling a luminance image of the video image, and vertically scaling a chrominance image of the video image.

28. The method of claim 27, wherein generating a clock signal comprises:
generating a reference clock signal;
dividing the reference clock signal by a predetermined integer M to generate a predivided clock signal;
generating an output clock signal based on the predivided clock signal and a feedback clock signal;
dividing the output clock signal by a predetermined integer S and a predetermined integer N to generate the feedback clock signal.

29. The method of claim 28, wherein N represents a number of input video lines in the video image, N is an integer multiple of 10, and S is selected from a group consisting of the values 1, 2, 3 and 4.

30. The method of claim 20, further comprising:
receiving the video image; and
translating the video image into the luminance image and the chrominance image.

31. The method of claim 20, further comprising centering the scaled video image.

32. The method of claim 20, wherein the video image comprises a plurality of input video lines and the scaled video image comprises a plurality of output video lines, the number of input video lines in the plurality of input video lines is a value within a predetermined range of integer values, and the number of output video lines in the plurality of output video lines is a value within a predetermined range of integer values.

33. The method of claim 32, wherein the plurality of scaling coefficients comprises a first coefficient and a second coefficient for an output video line in the video image, the first coefficient indicating a vertical distance between the output video line and a first input video line of the video image, the second coefficient representing a vertical distance between the output video line and a second input video line of the video image.

34. The method of claim 33, wherein the first input video line is adjacent to the second input video line in the video image.

35. The method of claim 33, wherein vertically scaling the luminance image comprises interpolating luminance data of the output video line based on the first coefficient and the second coefficient of the output video line, and wherein vertically scaling the chrominance image comprises interpolating chrominance data of the output video line based on the first coefficient and the second coefficient of the output video line.

36. The method of claim 33, wherein vertically scaling the luminance image further comprises filtering luminance data of the first input video line and the second input video line based on the first coefficient and the second coefficient of the output video line, and wherein vertically scaling the chrominance image comprises filtering chrominance data of the first input video line and the second input video line based on the first coefficient and the second coefficient of the output video line.

37. A system for scaling a video image to generate a scaled video image, the method comprising:
means for vertically scaling a luminance image of the video image;
means for vertically scaling a chrominance image of the video image; and
means for horizontally scaling the video image based on the vertically scaled luminance image and the vertically scaled chrominance image.

38. The system of claim 37, further comprising means for centering the scaled video image.
